(19) United States
(12) Patent Application Publication
(10) Pub. No.: US 2008/0080946 A1
(43) Pub. Date: Apr. 3, 2008

(54) Expansion pin system for a wind turbine structural tower

(76) Inventors: Tracy Livingston, Heber City, UT (US); Todd Andersen, Heber City, UT (US); Jared Quilter, Heber City, UT (US); David Oliphant, West Jordan, UT (US)

Correspondence Address: GRANT R CLAYTON;CLAYTON HOWARTH & CANNON, PC, P O BOX 1909, SANDY, UT, 84091-1909, US

(21) Appl. No.: 11/906,766

(22) Filed: Oct. 2, 2007

Related U.S. Application Data
(60) Provisional application No. 60/848,726, filed on Oct. 2, 2006.
(60) Provisional application No. 60/932,731, filed on Jun. 1, 2007.

(51) Int. Cl. F16B 39/04; B23P 11/00; F16B 39/10; F16B 43/00; F16B 35/00

(52) U.S. Cl. 411/54.1; 29/525.11; 411/120; 411/426; 411/533

(57) ABSTRACT

The disclosed invention is utilized for constructing a tower structure for a wind turbine and generally includes an expansion pin assembly.

### CROSS REFERENCE TO RELATED APPLICATIONS

This present application claims priority to U.S. Provisional Patent Application Ser. No. 60/848,675, filed Oct. 2, 2006, entitled “EXPANSION PIN SYSTEM FOR A WIND TURBINE STRUCTURAL TOWER.”

### STATEMENT REGARDING FEDERALLY SPONSORED RESEARCH OR DEVELOPMENT

Not Applicable.

### TECHNICAL FIELD

The present invention relates to wind turbines and structural towers and, more particularly, to equipment and methods used in assembling high elevation structural towers for wind turbines and for mounting wind turbines and blades upon high elevation structural towers.

### BACKGROUND

Wind turbines are an increasingly popular source of energy in the United States and Europe and in many other countries around the globe. In order to realize scale efficiencies in capturing energy from the wind, developers are erecting wind turbine farms having increasing numbers of wind turbines with larger turbines positioned at greater heights.

Towers of this size under go large force loads and may experience these loads in cyclical patterns, which can cause damage with in the structure members. These cycles may become resonating in nature and cause premature wear in the structure and may further cause failure. A rigid structure would not have cyclical patterns develop as readily as a non-rigid structure. However a perfectly rigid structure is more theoretical then real, yet the goal still remains to come as close the ideal as possible.

Dampening may also be used to interrupt the destructive force cycles. In damping applications where relatively little displacement occurs in order for the forces to be transferred into the damper it is necessary to lock intervening movement locations as much as possible so that the damper is working on the intended force. If the damper is acting on unintentional movement, say joint movement for example, rather then structural movement the damper will transfer the force rather then dampen it. Thus it is critical to lock any connection within a structure in order to properly dampen the structure.

Further details of the components making up such structural towers for wind turbine applications are presented in commonly-owned and pending U.S. patent application Ser. No. 11/433,147, entitled “STRUCTURAL TOWER,” commonly-owned and pending U.S. Provisional Patent Application Ser. No. 60/899,492, filed Feb. 5, 2007, entitled “WIND TURBINE SYSTEMS WITH DAMPING MEMBERS,” commonly-owned and pending U.S. Provisional Patent Application Ser. No. 60/848,725, filed Oct. 2, 2006, entitled “LIFTING SYSTEM FOR WIND TURBINE AND STRUCTURAL TOWER,” commonly-owned and pending U.S. Provisional Patent Application Ser. No. 60/848,726, filed Oct. 2, 2006, entitled “CLADDING SYSTEM FOR A WIND TURBINE STRUCTURAL TOWER,” commonly-owned and pending U.S. patent application Ser. No. 11/649,033, filed Jan. 3, 2007, entitled “LIFTING SYSTEM AND APPARATUS FOR CONSTRUCTING WIND TURBINE TOWERS,” commonly-owned and pending U.S. Provisional Patent Application Ser. No. 60/848,857, filed Oct. 2, 2006, entitled “SYSTEM AND APPARATUS FOR CONSTRUCTING AND ENCLOSING WIND TURBINE TOWERS,” commonly-owned and pending U.S. Provisional Patent Application Ser. No. 60/899,470, filed Feb. 5, 2007, entitled “WIND TURBINE SYSTEMS WITH WIND TURBINE TOWER DAMPING MEMBERS,” commonly-owned and pending U.S. patent application Ser. No. ______, filed Oct. 2, 2007, entitled “SYSTEM AND APPARATUS FOR CONSTRUCTING AND ENCLOSING WIND TURBINE TOWERS,” commonly-owned and pending U.S. patent application Ser. No. ______, filed Oct. 2, 2007, entitled “DRIVE PIN SYSTEM FOR A WIND TURBINE STRUCTURAL TOWER,” all of the disclosures of which are now incorporated herein in their entireties by this reference. The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure from the subject matter disclosed in the reference materials.

Additionally, as stated above these structures cost hundreds of thousands of dollars to construct in materials and construction costs. It is desirable to have the ability to perform maintenance on these structures to keep the working life span as long as possible. Metal bonding techniques have become popular for joining and can provide adequately rigid connections, however they tend to be less serviceable then mechanically joined connections. Where maintenance is preferable to rebuilding a bonded joint either made with an adhesive or welding, hinders maintenance and often requires replacement. A standard industry practice is to pin the damper end to the structure being damped, or where rigidity is desired. These standard pin joints still allow displacement enough to defeat effective dampening. A joint is needed to non-permanently connect the damper to the item or structure being damped with zero or near zero loss of the displacement. In cases where there is large displacement, this pinning approach is sufficient because the relatively small displacement loss-not transferred to the damper, due to tolerance slop in the pin joint—does not adversely influence the efficiency or operation of the damper. In cases where there is relatively small displacement, the amount of lost motion due to the slop, or free movement, of the pin in the connection of the damper to the structure can reduce the efficiency that the damper to the point of the damper is not effective. The expanding pin design allows for a damper to be connected to the structure in a non-permanent fashion while at the same time eliminating any free movement of the pin in the connection joint. This allows for all motion of the structure to be transferred through the joint and into the damper. Both for structural rigidity and any desired dampening applications a new connection joint is need.

It is possible that there are other applications where zero or near zero loss of displacement is needed which do not include a damper as one of the elements being connected to the structure, but possibly just two different members of the structure needing to be joined together. The expanding pin can be used in these applications also.

It is thus advantageous to be able to assemble high-elevation structural towers, to mount heavy wind turbines on the top of such towers without relying on relatively large and prohibitively expensive crane equipment, and hold those structures rigid for longevity and maintenance.

### BRIEF DESCRIPTION OF THE DRAWINGS

FIG. 1 illustrates a perspective view of a structural tower having a wind turbine assembly mounted thereon;

FIG. 2 illustrates a crane hoisting for assembly on top of the structural tower embodiment;

FIG. 3 illustrates an embodiment of an expansion pin assembly;

FIG. 4 illustrates a cut away of the embodiment of FIG. 3;

FIG. 5 illustrates a an embodiment of a tapered pin;

FIG. 6 illustrates a an embodiment of a tapered pin;

FIG. 7 illustrates a an embodiment of a tapered pin;

FIG. 8 illustrates a an embodiment of a tapered pin;

FIG. 9 illustrates a an embodiment of a wedge washer;

FIG. 10 illustrates a an embodiment of a wedge washer;

FIG. 11 illustrates a an embodiment of a studded washer;

FIG. 12 illustrates a an embodiment of a clamped washer;

FIG. 13 illustrates a an embodiment of a method of assembly of a expansion pin assembly;

FIG. 14 illustrates a an embodiment of a method of assembly of a expansion pin assembly;

FIG. 15 illustrates a an embodiment of a method of assembly of a expansion pin assembly;

FIG. 16 illustrates an embodiment of an expansion pin assembly;

FIG. 17 illustrates an embodiment of an expansion pin assembly.

### DETAILED DESCRIPTION

Generally, the present invention relates to an apparatus and methods used to assemble or construct high elevation structural towers supporting heavy loads, as in structural towers supporting wind turbines. In further detail, the present invention relates to an apparatus and method for providing a zero or near zero loss of displacement in a structural tower. In yet further detail, the present invention relates to an apparatus, system and method for a joining pin for assembling and constructing a high elevation structural. The present invention relates in particular to wind turbine applications, where the wind turbine is elevated to heights approaching eighty to one hundred meters or higher and where rotor diameters approach seventy meters or greater. Details of exemplary embodiments of the present invention are set forth below.

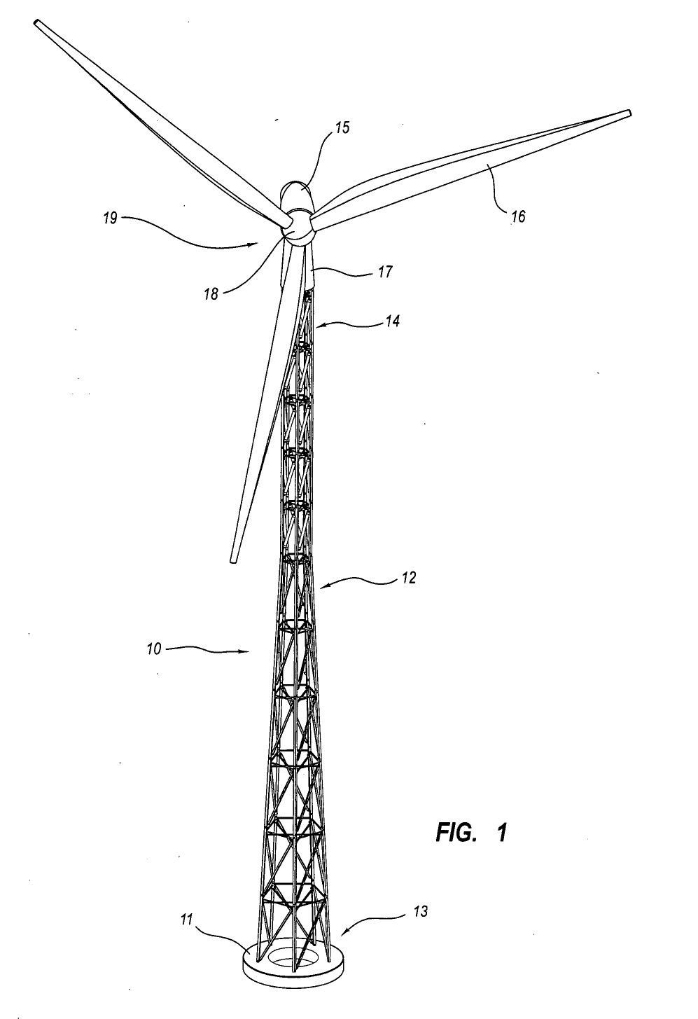

FIG. 1 illustrates a perspective view of a structural tower and wind turbine combination that is constructed and assembled using the present invention. Generally speaking, the structural tower 10 comprises a plurality of space frame sections also commonly called bay assemblies or bay sections 12, 13, 14 that are assembled, one on top of the other, to the desired height of the structural tower 10. The lowermost bay assembly 13 of the structural tower 10 is secured to a foundation 11. A series of intermediate 12 and upper 14 bay sections are assembled one on top of another to the desired height. The top bay section 17 may comprise a conventional tube-like bay section (as illustrated) or a space frame section (e.g., an upper bay section 14) and connects a wind turbine 15 to the top of the tower 10 using connections readily known to those skilled in the art. The wind turbine 15 carries a plurality of blades 16 mounted on a rotor 18 to form a blade assembly 19 that rotates in typical fashion in response to wind. Rotation of the blades 16 drives a generator (not illustrated) that is integral to the wind turbine 14 and typically used to generate electricity. As those skilled in the art will appreciate, the rotating plurality of blades 16 can be used for purposes other than generating electricity, such as, for example, driving a pump for pumping water or driving a mill for grinding grain. Further details of the components making up such high-elevation structural towers for wind turbine applications are presented in commonly-owned and pending U.S. patent application Ser. No. 11/433,147, the disclosure of which is incorporated in its entirety by this reference.

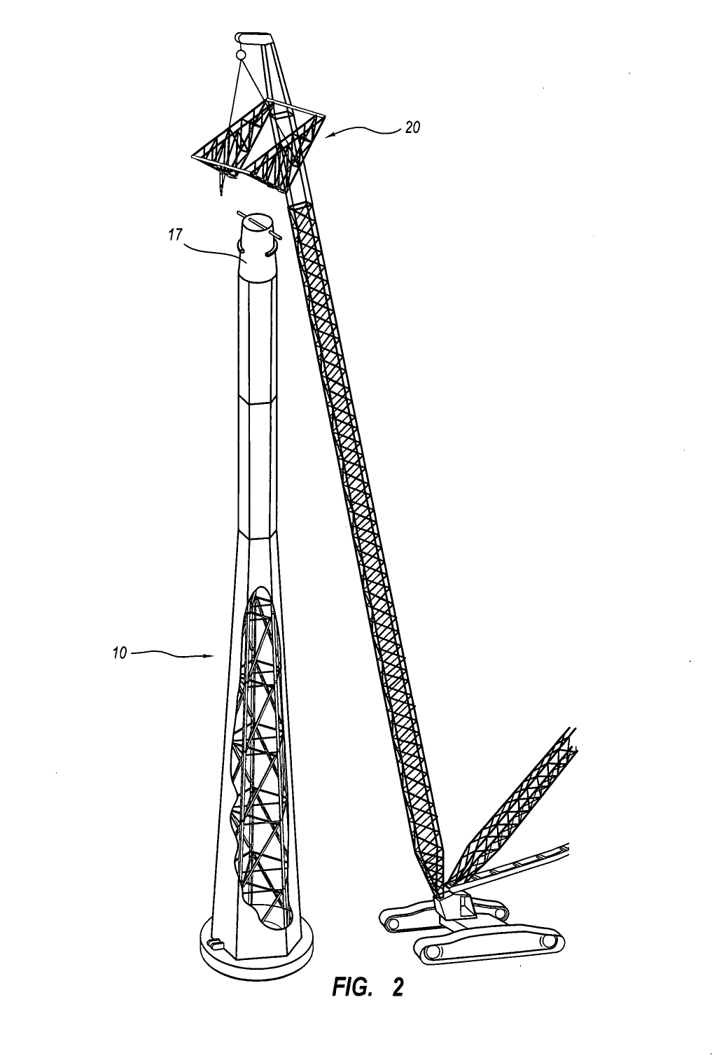

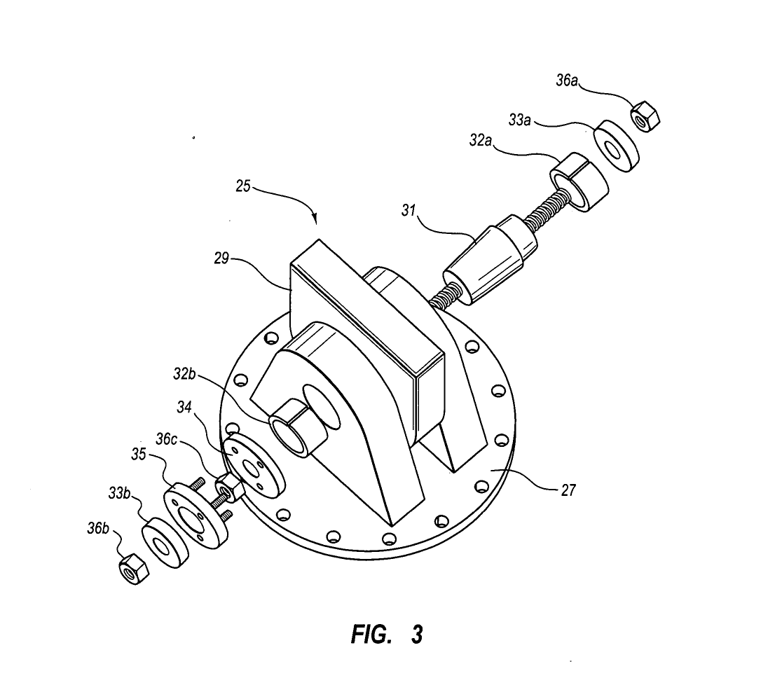

FIG. 2 illustrates one embodiment of a lifting apparatus 20 of the present invention being hoisted by a crane for positioning upon the top bay section 17 of the structural tower 10. As each piece is placed upon the other they may be joined by a series of connections. Referring now to FIG. 3 an embodiment of a connection will be discussed. The connector 25 is shown in this embodiment as having a male flange end 29 and a female end having two flanges joining together to form a connection 25. Accordingly a pin assembly is used to affix the connection 25. The pin assembly comprises a tapered pin 31 inserted in the corresponding male female joint of the connection 25. Tapered pin 31 is described in greater detail below. Following the tapered pin 31 in the assembly is a wedge washer 32a followed by a flat washer 33a that acts to press the wedge washer 32a over the tapered pin 31. Lastly for a first side of the assembly a nut 36a is threaded on to threads on the tapered pin 31 and holds the assembly together from a first side.

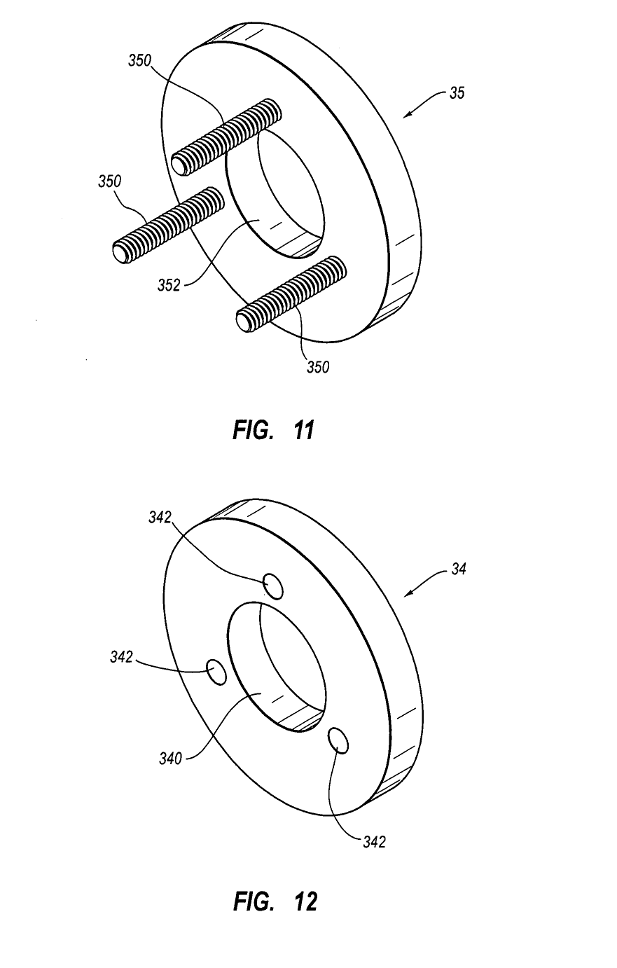

On a second side of the tapered pin 31 that protrudes through the second side of the joint, a second wedge washer 32b is inserted over the tapered pin 31. Following the wedge washer a clamping washer 34 may be placed over the drive pin 31. Clamping washer 34 will be discussed later in greater detail below. Following the clamping washer 34 a nut 36c may be threaded onto threads on the second end of the drive pin 31 to hold the clamping washer 34, and in turn the wedge washer 32b in position. The nut 36c is sized to impact the clamp 34 around the center hole 340 (FIG. 12) in the center of clamp washer 34. Following nut 36c a studded washer 35 is placed on to the tapered pin 31. The studded washer will be discussed in further detail below. The center hole 352 (FIG. 11) is sized to fit over and around nut 36c so that the studs 350 (FIG. 11) of the studded washer 35 can exert pressure on other components in the assembly without impacting or being impeded by the nut 36c. It should also be noted with reference to the assembly in FIG. 3, that the studs 350 correspond to radially placed holes on clamping washer 34 that allow the studs 350 to pass through and impact the wedge washer 32b, driving it forward while not impacting clamping washer 34. Following the studded washer 35, washer 33b is placed over the drive pin 31 to distribute forces from nut 36b on to the assembly. Nut 36b affixes the components on the second side of the connection 25.

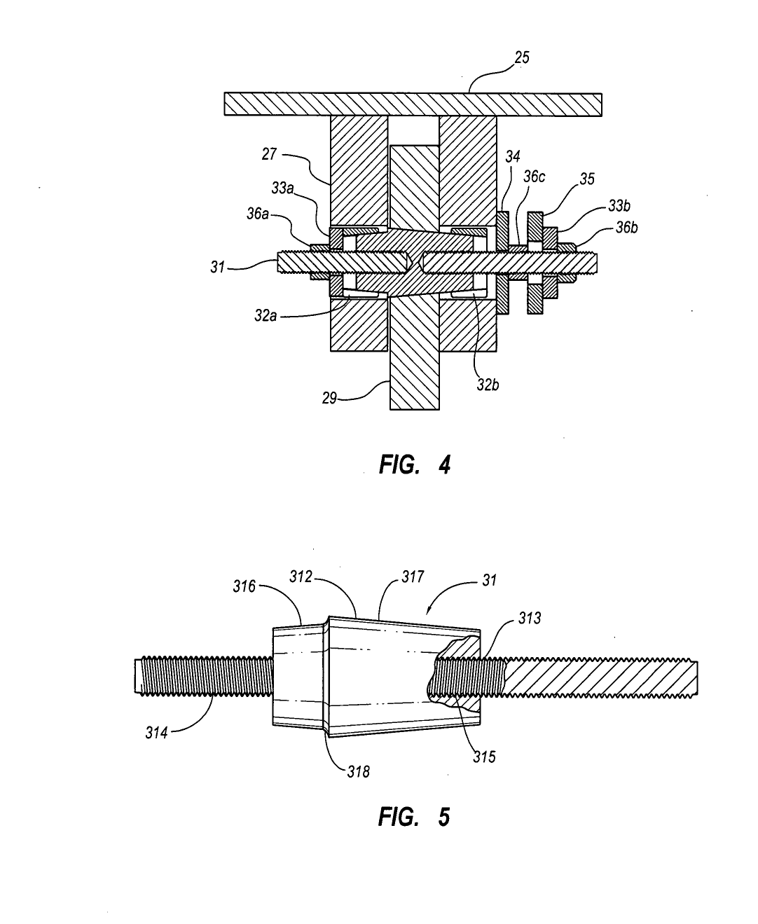

FIG. 4 demonstrates the interaction between the members of the assembly in cutaway view. The connector 25 is shown in this embodiment as having a male flange end 29 a female end having two flanges joining together to form a connection 25. Accordingly a pin assembly is used to affix the connection 25. The pin assembly comprises a tapered pin 31 inserted in the corresponding male female joint of the connection 25. Tapered pin 31 may generally sit centered in the connection.

Referring now to FIG. 4 and FIG. 5 greater detail will be disclosed concerning an embodiment of the tapered pin 31. The tapered pin 31 may comprise a body portion 312 and a stud portion 314 or stud portions 314a and 314b. The body 312 comprises a generally cylindrical form with a center slot 313 and stud 314 coaxial to the axis of the body 312.

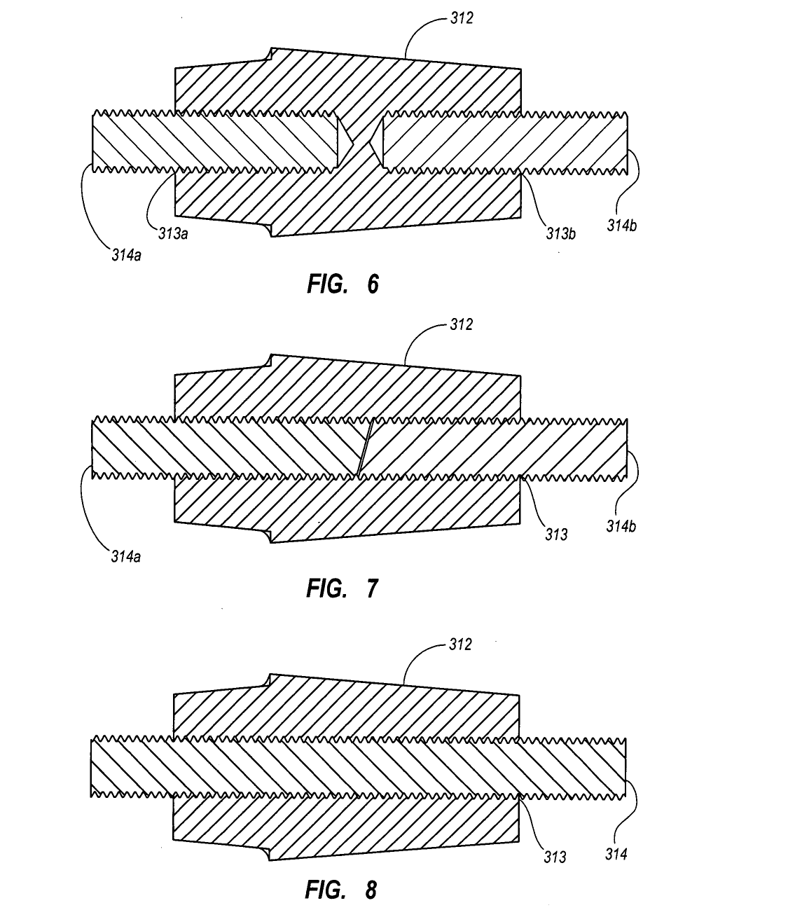

FIG. 6-FIG. 8 depict additional embodiments of the tapered pin 31 and the slots 313 and studs 314 therein. FIG. 6 depicts a body 312 with two separate coaxial slots 313 and 313 b. To form the tapered pin of FIG. 6 two separate studs 314a, 314b are affixed in the two slots 313a, 313b so that a predetermined length of stud 314 protrudes beyond the body 312.

FIG. 7 shows another embodiment of the drive pin 31. FIG. 7 depicts a body 312 with a single slot 313. To form the tapered pin of FIG. 7 two separate studs 314a, 314b are affixed in the slot 313 so that a predetermined length of stud 314 protrudes beyond the body 312. The studs 314a and 314b lock each other in by pressing upon each other with in the body 312.

FIG. 8 shows another embodiment of the drive pin 31. FIG. 8 depicts a body 312 with a single slot 313. To form the tapered pin of FIG. 8 a stud 314 is affixed in the slot 313 so that a predetermined length of stud 314 protrudes beyond the body 312.

The body 312 also may comprise tapered surfaces 316 and 317. It is the tapered surfaces 316 and 317 that provide the off axis expansion forces of the tapered pin 31 within the assembly. The tapered surface 316 tapers from larger toward the middle of the pin to smaller toward the protruding stud 314. As can be seen in FIG. 4 the tapered surface of the tapered pin 312 body are configured to physically communicate with the tapered surface 321 of a wedge washer 32. All tapered surfaces may be plated to define the characteristics of interaction between any physically communicating members of the assembly. Additionally, a tapered pin or wedge washer may be constructed of a relatively soft ductile material to encourage deformation of the tapered pin or washer. The taper of the taper pin 31 and wedge washer 32 may differ in the angles that defines the tapers. Additionally, the taper angles my be the same or similar.

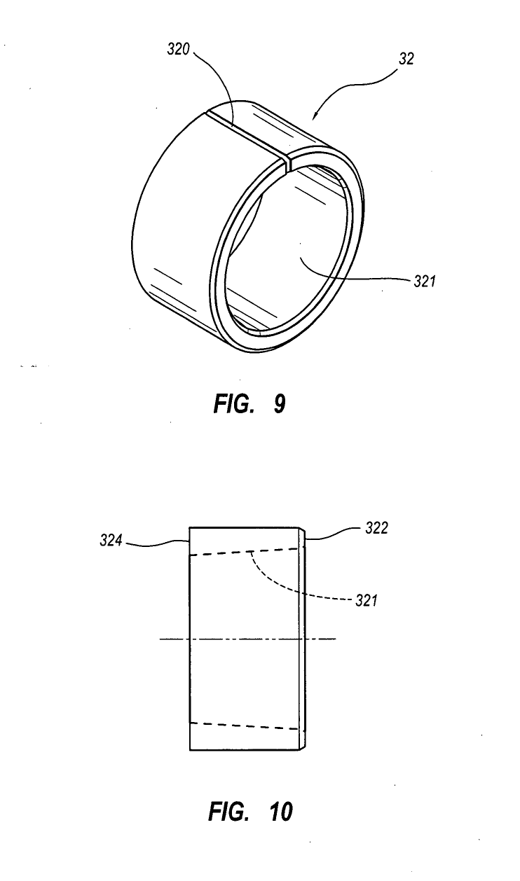

The wedge washer 32a is sized such that it fits within the connection holes of the male flange 29 and the female flanges 27. Referring to FIG. 9 and FIG. 10 an embodiment of the wedge washer 32 will be discussed. The wedge washer 32 displaces forces perpendicular to the axis of movement when working with a corresponding tapered pin. In other words, as the wedge washer 32 moves in physical communication upon tapered pin 31, surface 321 of the wedge washer 32 communicates with surface 316 of the tapered pin 31. The resultant force is perpendicular to their path of movement, causing the wedge washer 32 to expand, forming a tight fit within the flange 27. Wedge washer 32 is provided with a leading edge 322 sized such that it will fit over the corresponding end of the drive pin body 312. The wedge washer may also be provided with slot 320 for allowing for greater expansion of the washer. Lastly for a first side of the assembly, a washer 33a and a nut 32a are inserted on to the tapered pin 31 to hold the assembly together from a first side.

On a second side of the tapered pin 31 that protrudes through the second side of the forming joint, a second wedge washer 32b is inserted. Following the wedge washer a clamping washer 34 may be placed over the drive pin 31. Referring to FIG. 11 and FIG. 12 an embodiment of clamping washer 34 will be discussed. Clamping washer 34 has a center opening 340 sized such that it will fit over a stud 314 in drive pin 31 and allow for being retained by a nut 36. Additionally, clamping washer 34 may comprise a number of radially placed holes that allow the pass through of studs 350 of corresponding studded washer 35. Studded washer 35 and clamping washer 34 correspond to allow the isolation of movement of wedge washer 32b. This isolation is necessary to over come differences in tolerances in flanges. For example: if flanges 27 and 29 are overly thick wedge washer 34 would need to counter sink in to the connection openings in order to expand on tapered pin 31 enough to provide a zero slip connection. In order to provide the ability to exert continued pressure on the wedge washer 34 the studs 350 of the studded washer 35 penetrate the opening in the connection. The studs 350 may be placed radially about the axis of the washer. Typically, the number of studs 350 should be chosen to evenly distribute the driving force on the wedge washer 34. This embodiment demonstrates the use of three studs 350 distributed 120 degrees center to center radially. Other embodiments may use less or more. The center opening 352 of the studded washer 35 is sized such that if fits over nut 36c and can therefore exert force on the wedge washer 34 without impacting the nut 36c with holds clamping washer 34 in place. Following the studded washer 35, washer 33b is placed over the drive pin 31 to distribute forces from nut 36b on to the assembly. Nut 36b affixes the components on the second side of the connection 25. Additionally, a predetermined tension or torque may be applied to the assembly.

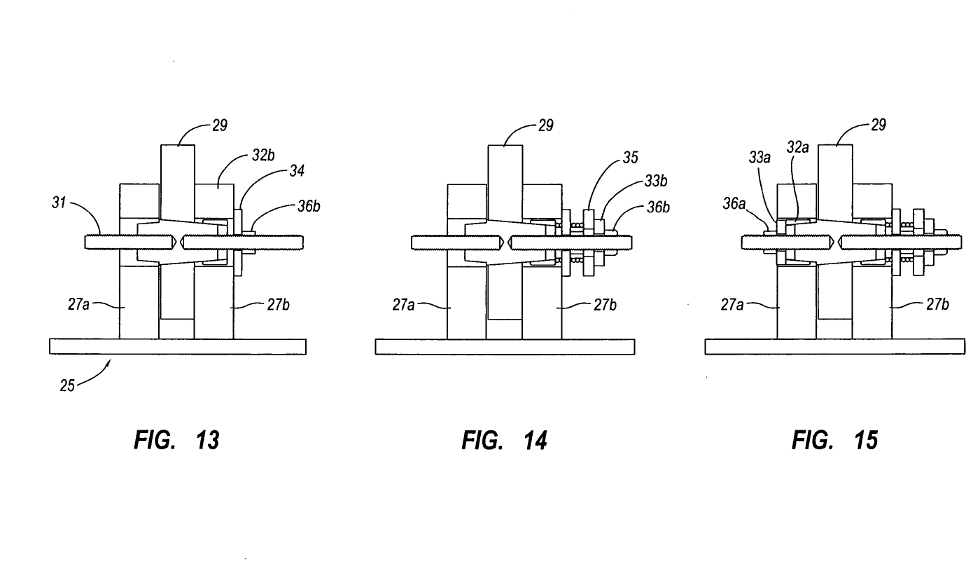

Referring FIG. 13-FIG. 15 an embodiment of a sequence of assembly will be discussed. With three flanges being pinned (either from a male/female interface between two members or from three separate members) the center flange 29 hole should optimally be tapered for increased joint strength. The design can work with the center flange's 27 hole not tapered but the joint strength may be reduced. The zero displacement fit has to be created between the expanding pin 31 and each of the three flanges 27a, 29, 27b. The zero displacement fit is created first between the center flange 29 and the tapered pin 31 by inserting the tapered pin 31 in flange 27a so that if the hole in flange 29 is tapered, the longer tapered surface of the tapered pin's 31 center body is aligned and mates up to the tapered surface in the hole of the center flange 29. The wedge washer 32, is then assembled over the tapered pin 31 and inserted into the hole in flange 27b. The wedge washer is sized such that once inserted into the flange 27b hole the outer surface of the wedge washer 32 is sub-flush of the outer surface of flange 27b. An alternative design allows for the outer surface of wedge washer 32 to be flush or even protrude out from the outer surface of flange 27b. In this alternate embodiment, clamping washer 35 is not a flat clamping washer but has an extending outer edge surface that allows it to not touch the wedge washer 32 as clamping washer 34 is pressed against the outer surface of flange 27b. After the wedge washer 32a is inserted over the tapered pin 31 and into the hole in flange 27b, the clamping washer 34 is applied by tightening down a hex nut 36b on the protruding threaded stud of the tapered pin 31 to pull the drive pin 31 through the connection until the long tapered surface of the tapered pin 31 and the tapered surface of the hole in flange 29 are tightly forced in to surface communication with each other. This action presses the clamp washer 34 against the outer surface of flange 27b while allowing wedge washer 32 to not be compressed into flange 27b. By not compressing wedge washer 32 at the same time it can be ensured that zero displacement fit is created between tapered pin 31 and flange 29.

Next the zero displacement fit is created between the wedge washer 32b and flange 27b. Because of possible thickness tolerances on the three tabs, and also length tolerances in the fabrication of the expanding pin and specifically tapered pin 31, it may not be possible to ensure that both flange 29 and flange 27b independently achieve a zero displacement fit at the same time through the clamping of clamping washer 34. The purpose of the studs on the studded washer 35 and the matching holes on item 34 now become apparent. Studded washer 35 is slid over tapered pin's 31 protruding threaded end. Aligning the studs on studded washer 35 so that they penetrate the holes on the clamping washer 34 allows studded washer 35 to be pushed toward flange 27b till the end surfaces of the studs on studded washer 35 press against the outer surface of wedge washer 32. A hex nut 36 is then used to press studded washer 35 forward which in turn presses wedge washer 32 further into the hole in flange 27b wedging it between the inner surface of the hole in flange 27b and the outer surface of the long tapered surface of tapered pin 31. This action creates the zero displacement fit between flange 27b and the expanding pin 31. A standard style flat washer 33b can be used between studded washer 35 and the hex nut 36 to help spread the load applied by the nut 36. The studs on studded washer 35 are sized long enough that they allow wedge washer 32 to travel to the zero displacement wedged position while preventing studded washer 35 from being stopped by the hex nut 36 securing clamping washer 34 in the desired position.

The zero displacement fit between flange 27a and the expanding pin 31 is created by inserting an wedge washer 32 into the hole in flange 27a and then applying a standard style flat washer 33a, sized just smaller than the flange 27a hole so that interference does not occur, and a hex nut 36a over the protruding expanding pin 31 threaded shaft and pressing the wedge washer 32 into the flange 27a hole till the zero displacement fit is created by wedging item wedge washer 32 between the inner surface of the hole in flange 27a and the outer surface of the shorter tapered surface of expanding pin 31.

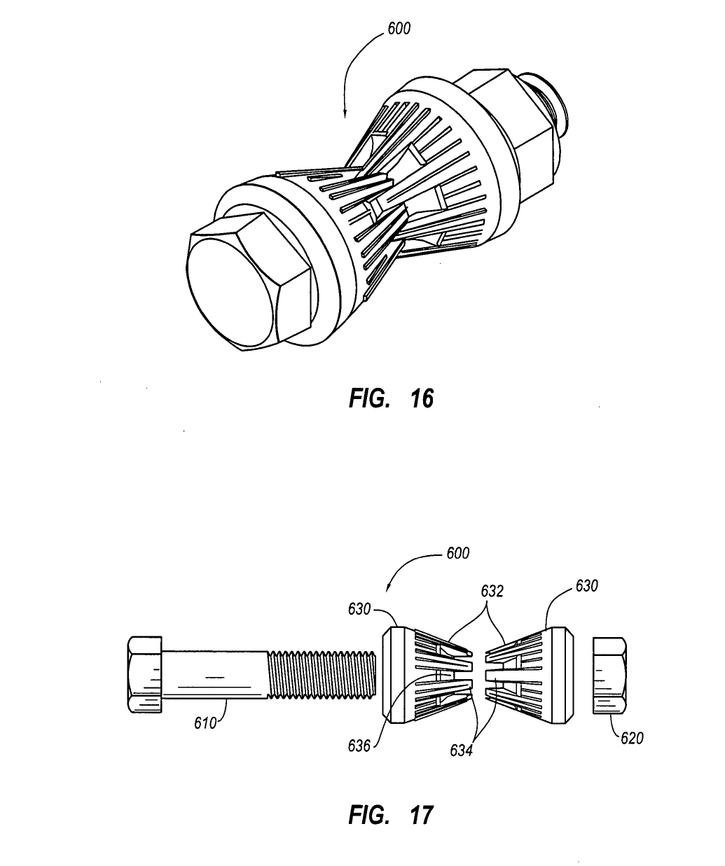

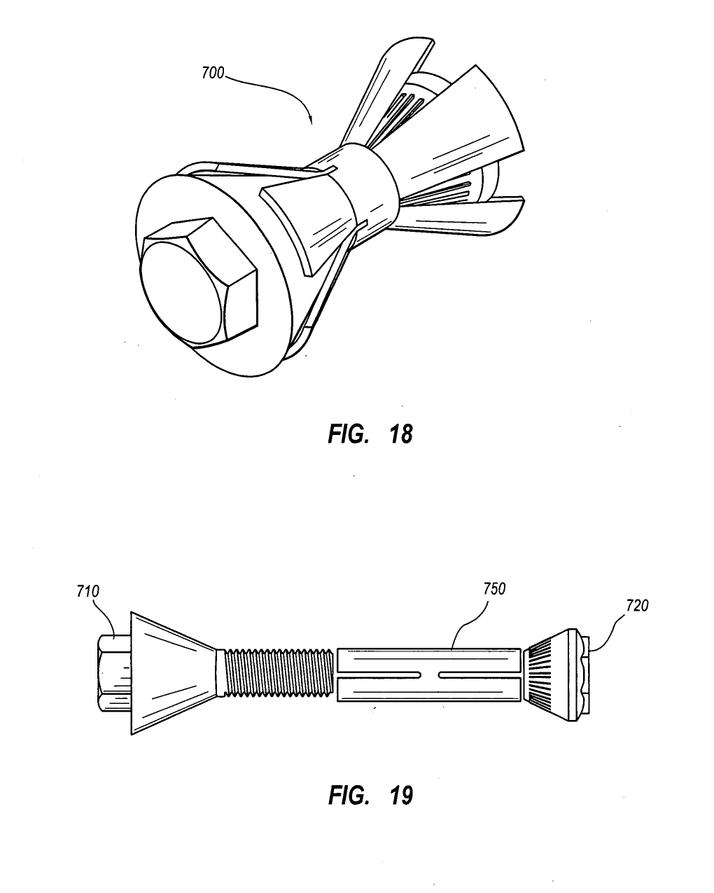

Referring to FIG. 16 and FIG. 17 an embodiment of an expansion pin assembly 600 will be discussed. Using standard production nut 620 and bolt 610 an expansion pin assembly may be created costing less with fewer specialized parts. There are opposing tapered penetrating washers 630 used on each side of the connection. The tapered penetrating washer 630 design includes a tapered face 632 allowing it to be driven by the nut 620 or bolt 610 in to the corresponding interweaving fingers 634 of the tapered penetrating washer 620 being driven in from the opposite side of the assembly 600. The tapered penetrating washer 630 has multiple fingers 634 that are an extension of the tapered face 632. In the space between fingers 634 resides a reverse slope 636 so that a fingers 634 from the first tapered washer 630 slide past the fingers 634 from the opposing approaching tapered washer 630 and the fingers of the opposing tapered washers 630 impact the reverse slopes of the opposing washer 630. As each finger 634 is forced onto the reverse slope 636 of the opposing tapered washer 630 the fingers spread out ward from the axial centerline of the bolt resulting in a larger circumference of the expanding pin assembly 600.

The tapered washer can be made out of different materials depending on the desired expansion and application. For example, if the joint requires all of the possible space with in the joint be filled, then the tapered washers can be fabricated from material, which is softer and flow as force is applied. If shear design capability is critical in the joint then the tapered washer can be fabricated from a material that will resist shear.

The tapered washer may further comprise knurling or and interrupted surface on the tapered slope 632. This interrupted surface allows for increased penetration of the tapered washer 630 into the other members of the assembly.

Additionally, the fingers 634 on the tapered washer 630 may be long enough, and the bolt and washers can be sized such that once fully engaged in the joint the fingers 634 extend beyond the outer surface of the opposing tapered washer 630. With the fingers engaged in the reverse slope areas of the tapered penetrating washer 630 the fingers can be deflected outwardly away from the center axis of the bolt 610. This creates both a locking interface between the tapered washer 630 and the structural members of the join (not shown), and also provides a constant and continual force locking against the bolt 610 and nut 620, further preventing the nut 620 from being able to walk off the bolt 610.

FIG. 18 and FIG. 19 depict another embodiment of an expansion pin assembly 700. Assembly 700 may comprise a wedge bolt 710 and wedge nut 720 that compress towards each other to compress and expand an expansion member 750.

Certain embodiments and details have been included herein and in the attached invention disclosure for purposes of illustrating the invention. Nevertheless, it will be apparent to those skilled in the art that various changes in the methods and apparatuses disclosed herein may be made without departing form the scope of the invention, which is defined in the appended claims.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An expanding tapered pin system for securing adjacent members of a structural tower for a wind turbine, comprising:
a pin member having a first portion and a second portion and a longitudinal axis, the first portion having a first taper in a first direction along the longitudinal axis and the second portion having a second taper in a second direction along the longitudinal axis, the pin further having first and second threaded members extending along the axis;
a first slotted washer member having an inner taper sized to engage the taper of the first portion of the pin;
a second slotted washer member having an inner taper sized to engage the taper of the second portion of the pin; and
means for securing the first slotted washer against the first tapered portion and means for securing the second slotted washer against the second tapered portion.

2. The expanding pin of claim 1, wherein the first slotted washer has an outside diameter sized such as to fit within an opening for joining on a member of a structural tower.

3. The expanding pin of claim 1, wherein the pin is constructed of high strength steel.

4. The expanding pin of claim 3, wherein the pin member is substantially plated.

5. The expanding pin of claim 4, wherein the plated portion is plated with nickel.

6. The expanding pin of claim 4, wherein the plated portion is plated with zinc.

7. The expanding pin of claim 1, wherein the means for securing the first slotted washer against the first tapered portion includes a washer and nut sized to engage the first threaded member.

8. The expanding pin of claim 1, wherein the means for securing the second slotted washer against the second tapered portion includes a washer and a nut sized to engage the second threaded member.

9. The expanding pin of claim 1, wherein the tapered pin is constructed of a ductile material to encourage deformation of the pin during assembly.

10. The expanding pin of claim 1, wherein said first slotted washer is constructed of ductile material in order to under go deformation during assembly.

11. The expanding pin of claim 1, wherein said first and second threaded members extending along the axis are made of a single piece.

12. The expanding pin of claim 1, wherein said first and second threaded members extending along the axis abut the other within the pin member.

13. An expansion pin assembly for joining members of a structural tower for a wind turbine comprising:
a tapered pin comprising a tapered portion having a slope at an angle measured from an axis of rotation,
a wedge washer comprising a tapered portion having a slope at an angle measured from an axis of rotation; and
wherein the tapered portion of said tapered pin is in physical communication with the tapered portion on said wedge washer.

14. The expansion pin assembly of claim 13 wherein said tapered pin comprises:
a body portion and a stud portion.

15. The expansion pin assembly of claim 14 wherein said tapered pin further comprises a plurality of stud portions.

16. The expansion pin assembly of claim 14 wherein said body comprises a slot.

17. The expansion pin assembly of claim 14 wherein said body comprises a plurality of slots.

18. The expansion pin assembly of claim 14 wherein said tapered portion of the tapered pin is plated.

19. The expansion pin assembly of claim 18 wherein said tapered portion is plated with a plating comprising predominantly nickel.

20. The expansion pin assembly of claim 18 wherein said tapered potion is plated with a plating comprising predominantly zinc.

21. The expansion pin assembly of claim 14 wherein said tapered pin comprises a plurality of the tapered surfaces.

22. The expansion pin assembly of claim 14 wherein said wedge washer comprises a tapered inner surface.

23. The expansion pin assembly of claim 13 further comprising a studded washer.

24. The expansion pin assembly of claim 23 wherein the studded washer comprises a plurality of studs radially placed.

25. The expansion pin assembly of claim 13 further comprising a clamping washer.

26. The expansion pin assembly of claim 25 wherein the clamping washer comprises a plurality of radially placed openings.

27. A method for of assembling an expansion pin assembly for constructing a structural tower for a wind turbine comprising:
placing a male tab of a flange gusset connection between two female tabs of a flange gusset connection forming a connection;
inserting a tapered pin having a first proximal end and second distal end into the connection;
co-axially with the tapered pin placing a wedge washer on to the first end of the tapered pin;
co-axially with the tapered pin placing a wedge washer on to the second end of the tapered pin; co-axially with the tapered pin placing a clamp washer on to the second end of the tapered pin;
co-axially with the tapered pin placing a studded washer on to the second end of the tapered pin; and affixing the assembly on the first end and second end.

28. An expansion pin assembly for joining members of a structural tower for a wind turbine comprising: a pair of opposing tapered penetrating washers having corresponding a finger and a revers slope portion configured such that an opposing finger portion is driven over a corresponding revers slope portion when driven together on a mutually coaxial standard bolt.

29. The expansion pin assembly of claim 28 further comprising a plurality of finger portions.

30. The expansion pin assembly of claim 28 further comprising a plurality of reverse slope portions.

31. An expansion pin assembly for joining members of a structural tower for a wind turbine comprising: a wedge bolt and a wedge nut configured such that when the wedge nut is driven onto the wedge bolt an expansion member is expanded by the wedge portion of the wedge bolt and the wedge portion of the wedge nut.

32. The method of claim 27 further comprising affixing the assembly to a predetermined tension.
